(19) United States
(12) Patent Application Publication
(10) Pub. No.: US 2026/0297438 A1
(43) Pub. Date: Oct. 1, 2026

(54) DEMULSIFYING METHOD

(71) Applicant: INNOSPEC LIMITED, Ellesmere Port (GB)

(72) Inventors: Romain DESNOS, Saint Marcel (FR); Elise GUIMARD, Saint Marcel (FR); Hubert JUNGBLUTH, Herne (DE)

(21) Appl. No.: 19/479,487

(22) PCT Filed: May 3, 2024
(86) PCT No.: PCT/GB2024/051167

§ 371 Date: Oct. 28, 2025

(30) Foreign Application Priority Data
May 3, 2023 (GB) 2306540.2

(51) Int. Cl. C10G 33/04; C08G 81/00

(52) U.S. Cl. CPC C10G 33/04; C08G 81/00; C10G 2300/1033

(57) ABSTRACT

A method of demulsifying a hydrocarbon emulsion, the method including adding an additive composition to the hydrocarbon emulsion, wherein the additive composition comprises (i) one or more alkoxylated amine compounds and (ii) one or more aldehyde-alkylphenol copolymers.

### FIELD

The present invention relates to a method of demulsifying a hydrocarbon emulsion and to the use of an additive composition to demulsify a hydrocarbon emulsion. In particular the present invention relates to a method of demulsifying a hydrocarbon emulsion using an additive composition comprising one or more alkoxylated amine compounds and one or more aldehyde acylphenol copolymers.

### BACKGROUND

Hydrocarbons such as crude oil (produced from geological formations) typically contain inorganic salts, such as calcium, sodium and magnesium chlorides. These salts may cause precipitate and emulsion formation, which can lead to operational problems such as the obstruction of flow through pipes, corrosion, increased heat capacity, fouling of equipment, and/or poisoning of catalysts. Such salts are therefore removed before processing of the hydrocarbons.

Inorganic salts are typically removed from the hydrocarbons by washing with an aqueous component such as water. However, such water washing produces undesirable water-hydrocarbon emulsions and if not removed, the water may cause corrosion to equipment, such as processing and distillation equipment. Water may also be introduced into hydrocarbons during processing and/or storage, again leading to the formation of undesirable emulsions.

An aqueous component such as water may be separated from an emulsion using an appropriate emulsion-breaking additive (also termed an emulsion breaker) or demulsifier, and following separation, the aqueous component such as water may be removed by a suitable method.

Known demulsifiers include alkylphenol formaldehyde resin alkoxylates (AFRA), polyalkylene glycols (PAG), organic sulfonates and alkoxylated amines. Whilst these demulsifiers do act to demulsify hydrocarbon emulsions, they typically do not function quickly and/or provide clean separation of the aqueous component from the hydrocarbon. If clean separation is not obtained, then the aqueous component such as water may be retained in the demulsified hydrocarbon and/or significant quantities of hydrocarbon may be lost when the aqueous component is removed. Additionally undesirable quantities of dirt may be introduced into the hydrocarbon from the aqueous component.

Thus, there remains a need for alternative and/or improved methods for demulsifying hydrocarbon emulsions, for example which separate an aqueous component such as water quickly and/or which provide clean separation of the aqueous component from the hydrocarbon. For example, it is desirable to minimise residual emulsion, avoiding traces of hydrocarbon in the aqueous component which are later discarded and lost.

It is thus an object of the present invention to provide methods of demulsifying a hydrocarbon emulsion, which methods may be more effective than, or which may provide an alternative to, existing methods of demulsifying hydrocarbon emulsions.

### SUMMARY

According to a first aspect of the present invention, there is provided a method of demulsifying a hydrocarbon emulsion, the method comprising adding an additive composition to the hydrocarbon emulsion, wherein the additive composition comprises (i) one or more alkoxylated amine compounds and (ii) one or more aldehyde-alkylphenol copolymers.

According to a second aspect of the present invention, there is provided the use of an additive composition to demulsify a hydrocarbon emulsion, wherein the additive composition comprises (i) one or more alkoxylated amine compounds and (ii) one or more aldehyde-alkylphenol copolymers.

According to a third aspect of the present invention, there is provided a method of improving the demulsification of a hydrocarbon emulsion, the method comprising adding an additive composition to the hydrocarbon emulsion, wherein the additive composition comprises (i) one or more alkoxylated amine compounds and (i) one or more aldehyde-alkylphenol copolymers.

According to a fourth aspect of the present invention, there is provided the use of an additive composition to improve the demulsification of a hydrocarbon emulsion, wherein the additive composition comprises (i) one or more alkoxylated amine compounds and (ii) one or more aldehyde-alkylphenol copolymers.

According to a fifth aspect of the present invention, there is provided a method of improving the demulsification action of one or more alkoxylated amine compounds in a hydrocarbon emulsion, the method comprising admixing the one or more alkoxylated amine compounds with one or more aldehyde-alkylphenol copolymers to provide an additive composition, and adding the additive composition to the hydrocarbon emulsion.

According to a sixth aspect of the present invention, there is provided the use of one or more aldehyde-alkylphenol copolymers to improve the demulsification action of one or more alkoxylated amine compounds in a hydrocarbon emulsion.

The use of an additive composition comprising a combination of (i) one or more alkoxylated amine compounds and (ii) one or more aldehyde-alkylphenol copolymers has been found to provide unexpected advantages. For example, although alkoxylated amine compounds are known as demulsifiers, it was surprisingly found that the addition of one or more aldehyde-alkylphenol copolymers (which are known to be dispersants) to one or more alkoxylated amine compounds improves the demulsification action of the one or more alkoxylated amine compounds, such as by accelerating the speed of separation, improving clean separation of the aqueous component (for example water) from the hydrocarbon component, increasing the volume of water separated and/or minimising residual (or unresolved) emulsion.

### DETAILED DESCRIPTION

Unless otherwise stated, the following terms used in the specification and claims have the meanings set out below.

The terms “alkyl” and “alkylene” include both straight and branched chain alkyl and alkylene groups respectively unless otherwise stated.

The term “aryl” as used herein refers to an organic moiety derived from an aromatic hydrocarbon by removal of one hydrogen, and includes any monocyclic, bicyclic or polycyclic carbon ring of up to 7 members in each ring, wherein at least one ring is aromatic.

The term “aralkyl” as used herein refers to alkyl moieties substituted with an aryl group, wherein the aryl group is an organic moiety derived from an aromatic hydrocarbon by removal of one hydrogen, and includes any monocyclic, bicyclic or polycyclic carbon ring of up to 7 members in each ring, wherein at least one ring is aromatic. An example of an aralkyl group is a benzyl group. The term “hydrocarbyl” is used in its ordinary sense, which is well-known to those skilled in the art. Specifically, it refers to a group having a carbon atom directly attached to the remainder of the molecule and having predominantly hydrocarbon character.

As used in the specification and the appended claims, the singular forms “a”, “an,” and “the” include both singular and plural referents unless the context clearly dictates otherwise.

Throughout this specification, the term “comprising” or “comprises” means including the component(s) specified but not to the exclusion of the presence of other components. The term “consisting essentially of of” consists essentially of means including the components specified but excluding other components except for components added for a purpose other than achieving the technical effect of the invention. The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

As used herein, unless otherwise expressly specified, all numbers such as those expressing values, ranges, amounts of percentages may be read as if prefaced by the word “about”, even if the term does not expressly appear.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.70 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The optional features set out herein may be used either individually or in combination with each other where appropriate and particularly in the combinations as set out in the accompanying claims. The optional features for each exemplary aspect of the invention, as set out herein are also applicable to any other aspects or exemplary aspects of the invention, where appropriate. In other words, the sidled person reading this specification should consider the optional features for each aspect or embodiment of the invention as interchangeable and combinable between different aspects of the invention.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

In this specification any reference to ppm is to parts per million by weight.

According to a first aspect of the present invention there is provided a method of demulsifying a hydrocarbon emulsion, the method comprising adding an additive composition to the hydrocarbon emulsion, wherein the additive composition comprises (i) one or more alkoxylated amine compounds and (ii) one or more aldehyde-alkylphenol copolymers.

According to a second aspect of the present invention, there is provided the use of an additive composition to demulsify a hydrocarbon emulsion, wherein the additive composition comprises (i) one or more alkoxylated amine compounds and (ii) one or more aldehyde-alkylphenol copolymers.

The term “hydrocarbon emulsion” would be well understood by a person skilled in the art to mean an emulsion comprising a hydrocarbon component and an aqueous component. Typically, the hydrocarbon emulsion will comprise an aqueous component dispersed in a hydrocarbon component, such as droplets of the aqueous component dispersed throughout the hydrocarbon component wherein the aqueous component is not soluble in or miscible with the hydrocarbon component. For example, the hydrocarbon emulsion may be known as a water in hydrocarbon, or a water in oil, emulsion.

By demulsifying a hydrocarbon emulsion we mean to separate an aqueous component from a hydrocarbon component of the hydrocarbon emulsion. Thus, by separating the aqueous component, this provides the hydrocarbon in a form that is substantially free or is free of the aqueous component such that no emulsion is provided (i.e. such that demulsification occurs). The amount of separation can be termed the level of demulsification, by which we mean the volume of the aqueous component that is separated from the hydrocarbon component of the hydrocarbon emulsion. The level of demulsification (or separation) may be measured using any suitable method, such as the method described in the examples provided herein. Thus, references herein to “demulsifying”, “demulsification”, “demulsify” and suchlike would be well understood by persons skilled in the art. For example, these terms would be well understood to refer to separating, or improving the separation of, an emulsion, for example to substantially or completely separate the components of the emulsion. Preferably, the demulsification provides a clean interface between the aqueous and the hydrocarbon components of the emulsion.

By “substantially free of the aqueous component” we mean that any aqueous component (or water) that is present, if any, is present as an incidental impurity. By “free of the aqueous component” we mean that no aqueous component (or water) is present.

The method of the first aspect of the invention comprises adding an additive composition to the hydrocarbon emulsion, wherein the additive composition comprises (i) one or more alkoxylated amine compounds and (ii) one or more aldehyde-alkylphenol copolymers.

The use of the second aspect of the invention refers to the use of an additive composition to demulsify a hydrocarbon emulsion, wherein the additive composition comprises (i) one or more alkoxylated amine compounds and (ii) one or more aldehyde-alkylphenol copolymers.

Thus, both the method and use of the invention make use of an additive composition that comprises (i) one or more alkoxylated amine compounds and (ii) one or more aldehyde-alkylphenol copolymers. It has been surprisingly found that the additive composition acts to demulsify a hydrocarbon emulsion. The additive composition may suitably improve or enhance the demulsifying effect compared to the use of an alkoxylated amine compound alone. For example, the demulsifying effect may be enhanced by accelerating the demulsification, providing a clean interface between the aqueous and the hydrocarbon components and/or minimising residual emulsion in the aqueous component. For example, the additive composition may accelerate the demulsification of a hydrocarbon emulsion compared to the use of an alkoxylated amine compound alone and/or may provide complete demulsification of a hydrocarbon emulsion in a time period of 10 to 60 minutes, for example 10 to 45 or 10 to 40 minutes, such as 10 to 20 minutes.

The additive composition may, for example, improve the level of demulsification (or separation) of a hydrocarbon emulsion compared to a hydrocarbon emulsion without the additive composition at intervals after addition of the additive composition (when present), for example after 10 minutes, after minutes or after 60 minutes.

For example, the level of demulsification (or separation) of a hydrocarbon emulsion may be measured 10 minutes after addition of the additive composition thereto and compared to the hydrocarbon emulsion without the additive composition. After 10 minutes, an improvement (or increase) in the level of demulsification (or separation) of at least 500%, for example at least 750%, suitably at least 1000% or at least 1500% may be achieved for the hydrocarbon emulsion with the additive composition added compared to the hydrocarbon emulsion without the additive composition.

For example, the level of demulsification (or separation) of a hydrocarbon emulsion may be measured 60 minutes after addition of the additive composition thereto and compared to the hydrocarbon emulsion without the additive composition. After 60 minutes, an improvement (or increase) in the level of demulsification (or separation) of at least 0.5%, for example at least 1.0%, or at least 1.5% or at least 2.0%, suitably at least 2.5% or at least 10% may be achieved for the hydrocarbon emulsion with the additive composition added compared to the hydrocarbon emulsion without the additive composition.

As the skilled person will appreciate, when handling and processing bulk hydrocarbons in an industrial setting any improvement in the level and/or speed of demulsification (or separation) provides a significant advantage.

The additive composition comprises one or more alkoxylated amine compounds. The additive composition may comprise one alkoxylated amine compound. The additive composition may comprise two or more alkoxylated amine compounds.

The additive composition may comprise any alkoxylated amine compound(s). By an “alkoxylated amine compound” we mean to include any compound including one or more amine functional groups which has been reacted with at least one alkylene oxide moiety, i.e. such that the compound comprises one or more amine functional groups and at least one alkylene oxide residue. Such compounds will be known to persons skilled in the art.

Preferably the alkoxylated amine compounds include more than one alkylene oxide residue.

Suitable alkylene oxide residues include ethylene oxide residues, propylene oxide residues, butylene oxide residues and mixtures thereof.

Preferably the alkoxylated amine compounds include ethylene oxide residues, propylene oxide residues, or mixtures thereof.

The one or more alkoxylated amine compounds may each comprise one or more alkylene oxide residues independently selected from ethylene oxide residues, propylene oxide residues and butylene oxide residues.

Preferably the one or more alkoxylated amine compounds are independently selected from one or more of an alkoxylated monoamine and one or more of an alkoxylated polyamine (which may be an alkoxylated diamine). By polyamine we mean a compound including two or more amine groups (including a diamine compound).

Some preferred alkoxylated amine compounds for use herein have the formula A-(RO)ⁿ—H wherein A is the residue of an amine and RO is an alkylene oxide residue (i.e. wherein R represents an alkylene moiety) and n is at least one.

R is preferably an ethylene, propylene or butylene group. R may be an n-propylene or n-butylene group or an isopropylene or isobutylene group. For example R may be —CH₂CH₂—, —CH₂CH(CH₃)—, —CH₂C(CH₃)₂, —CH(CH₃)CH(CH₃)— or —CH₂CH(CH₂CH₃)—.

R may comprise a mixture of isomers. For example when R is propylene, the alkylene oxide residue may include the moieties —CH₂CH(CH₃)— and —CH(CH₃)CH₂— in any order within the chain.

Each R may be the same or different. R may comprise a mixture of different alkylene moieties, for example ethylene, propylene or butylene moieties. Block copolymer units are preferred in this case.

Preferably R is ethylene and/or propylene. More preferably R is —CH₂CH₂— and/or —CH(CH₃)CH—, such as —CH₂CH₂— or —CH(CH₃)CH—.

Preferably the one or more alkoxylated amine compounds comprise a mixture of ethylene oxide residues and propylene oxide residues.
n is at least 1. Preferably n is from 5 to 1000, preferably from 5 to 500, more preferably from 10 to 400, more preferably from 15 to 300, preferably from 20 to 250, suitably from 30 to 200, preferably from 50 to 150.

A is the residue of an amine. Suitably A is the residue of an amino or polyamino compound having at least one NH group. Suitable amino compounds include primary, secondary, and tertiary monoamines having hydrocarbon substituents of 1 to 30 carbon atoms or hydroxyl-substituted hydrocarbon substituents of 1 to about 30 carbon atoms.

Preferably the amino compounds include tertiary monoamines having hydroxyl-substituted alkyl substituents of 1 to 5 carbon atoms. Suitably each substituent is the same.

Suitable monoamines may, for example, be selected from triethanolamine, diethanolamine, ethanolamine, tri-n-propanolamine, di-n-propanolamine, n-propanolamine, triisopropanolamine, diisopropanolamine, and isopropanolamine.

A preferred monoamine is triethanolamine.

Suitably A is the residue of a polyamine.

Polyamines may be selected from any compound including two or more amine groups. Preferably the polyamine is a (poly)alkylene polyamine (by which is meant an alkyene polyamine or a polyalkylene polyamine; including in each case a diamine, within the meaning of “polyamine”). Preferably the polyamine is a (poly)alkylene polyamine in which the alkylene component has 1 to 6, preferably 1 to 4, most preferably 2 to 3, carbon atoms. Most preferably the polyamine is a (poly)ethylene polyamine (that is an ethylene polyamine or a polyethylene polyamine).

Preferably the polyamine has 2 to 15 nitrogen atoms, preferably 2 to 10 nitrogen atoms, more preferably 2 to 8 nitrogen atoms.

The polyamine may, for example, be selected from ethylenediamine, diethylenetriamine, triethylenetetramine, tetraethylenepentamine, pentaethylene-hexamine, hexamethylenetetramine, heptaethyleneoctamine, propane-1,2-diamine, 2(2-amino-ethylamino)ethanol, N′,N′-bis(2-aminoethyl) ethylenediamine (N(CH₂CH₂NH₂)₃), diphenyl 4,4′-diamine, diamino naphthalene, phenylene diamine, xylene diamine, 1,2-diaminopropane and 1,3-diaminopropane, 1,4-diaminobutane, 1,5-diamino pentane and 1,6-diamino hexane.

A preferred polyamine is ethylenediamine.

Most preferably A is the residue of ethylenediamine or triethanolamine.

The one or more alkoxylated amine compounds may be selected from one or more compounds of formula (IA):

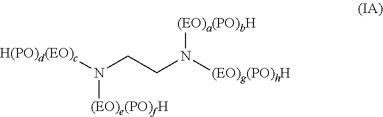

wherein EO represents an ethylene oxide residue, PO represents a propylene oxide residue and at least one of a, b, c, d, e, f, g and h is not 0.

The compounds of formula (IA) may be prepared by reaction of ethylene diamine with ethylene oxide and propylene oxide (when both present) in any combination thereof and in any order, i.e. so as to provide compounds of formula (IA) in which the ethylene oxide and propylene oxide residues may be present in any combination and in any order as bonded to the nitrogen of the amine group.

Preferably the compounds of formula (IA) are prepared by reaction of ethylene diamine with ethylene oxide, removal of residual ethylene oxide, followed by subsequent reaction with propylene oxide, such that a block copolymer is formed.

Preferably each of a, b, c, d, e, f, g and h is at least one. Preferably the sum of a, b, c, d, e, f, g and h is from 10 to 500, suitably from 20 to 250, preferably from 40 to 200, more preferably from 50 to 150.

The one or more alkoxylated amine compounds may be selected from one or more compounds of formula (IB):

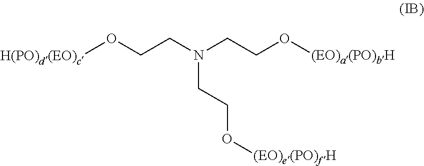

wherein EO represents an ethylene oxide residue, PO represents a propylene oxide residue and at least one of a′, b′, c′, d′, e′, and f′ is not 0.

The compounds of formula (IB) may be prepared by reaction of triethanolamine with ethylene oxide and propylene oxide (when both present) in any combination thereof and in any order, i.e. so as to provide compounds of formula (IB) in which the ethylene oxide and propylene oxide residues may be present in any combination and in any order as bonded to the oxygen of the ethoxy group.

Preferably the compounds of formula (IB) are prepared by reaction of triethanolamine with ethylene oxide, removal of residual ethylene oxide, followed by subsequent reaction with propylene oxide, such that a block copolymer is formed.

Preferably each of a′, b′, c′, d′, e′, and f is at least one. Preferably the sum of a′, b′, c′, d′, e′, and f′ is from 10 to 500, suitably from 20 to 250, preferably from 40 to 200, more preferably from 50 to 150.

The skilled person will appreciate that polymeric compounds of formulae (IA) and (IB) are usually in the form of mixtures. In the compounds of formulae (IA) and (IB) the ethylene oxide and propylene oxide residues may be present in any combination and in any order as bonded to the nitrogen or oxygen of the amine or ethoxy groups respectively.

The one or more alkoxylated amine compounds may be selected from one or more compounds of formula (IA) and/or one or more compounds of formula (IB).

Some suitable alkoxylated amine compounds for use herein are described in U.S. Pat. No. 6,838,422.

Preferably the one or more alkoxylated amine compounds have a number average molecular weight of from 500 to 20000, preferably from 1000 to 15000, more preferably from 2000 to 12000, for example from 2500 to 10000.

The additive composition may comprise the one or more alkoxylated amine compounds in any suitable amount. For example, the additive composition may comprise at least 5 wt %, such as at least 10 wt % or at least 15 wt % of the one or more alkoxylated amine compounds, and/or the additive composition may comprise up to 45 wt %, such as up to 40 wt % or up to 35 wt % of the one or more alkoxylated amine compounds. The additive composition may, for example, comprise from 5 to 45 wt %, or from 10 to 40 wt %, such as from 15 to 35 wt %, of the one or more alkoxylated amine compounds.

The additive composition comprises one or more aldehyde-alkylphenol copolymers. The additive composition may comprise two or more aldehyde-alkylphenol copolymers.

The additive composition may comprise any aldehydes-alkylphenol copolymer(s). Such copolymers will be known to persons skilled in the art. The aldehyde-alkylphenol copolymer(s) do not comprise any alkoxy groups or residues, i.e. the aldehyde-alkylphenol copolymer(s) are non-alkoxylated.

The aldehyde-alkylphenol copolymers may be prepared by copolymerising an aldehyde compound and an alkylphenol compound.

Preferably the aldehyde compound used to prepare the aldehyde-alkylphenol copolymers is selected from formaldehyde or a reactive equivalent thereof (for example paraformaldehyde), C₂ to C₁₀ aldehydes and aromatic aldehydes (for example benzaldehyde).

Preferred aldehyde-alkylphenol copolymers are copolymers of formaldehyde and an alkylphenol compound. The one or more aldehyde-alkylphenol copolymers may be selected from one or more copolymers of formaldehyde and an alkylphenol.

Preferably the alkylphenol compound used to prepare the aldehyde-acylphenol copolymers is mono-substituted with an alkyl group, preferably at the pare position. Preferred alkyl groups have 1 to 40 carbon atoms, preferably 2 to 36 or 9 to 36 carbon atoms, more preferably 4 to carbon atoms, for example 4 to 28 or 4 to 24 carbon atoms, or for example 6 to 28 or 6 to 24 carbon atoms. The alkylphenol compound may suitably be a C₂-C₃₆ or a C₉-C₃₆ or a C₄-C₂₈ alkyl substituted phenol.

The alkylphenol compound may suitably be a polyisobutenyl (PIB) substituted phenol. Polyisobutenyl (PIB) substituted phenols include a hydrocarbyl chain having the repeating unit

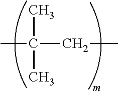

wherein m is from 3 to 54.

Poly(isobutenes) are prepared by the addition polymerisation of isobutene, (CH₃)₂C═CH₂. Each molecule of the resulting polymer will include a single alkene moiety.

Conventional polyisobutenes and so-called “highly-reactive” polyisobutenes are suitable for use in preparing the alkylphenol compounds. Highly reactive polyisobutenes in this context are defined as polyisobutenes wherein at least 50 mol %, preferably 70 mol % or more, of the terminal olefinic double bonds are of the vinylidene type as described in EP0565285. Particularly preferred polyisobutenes are those having more than 80 mol % and up to 100 mol % of terminal vinylidene groups such as those described in EP1344785.

Methods of preparing alkylphenol compounds, for example polyisobutene substituted phenols, are known to the person skilled in the art, and include the methods described in EP631141.

The PIB substituent of a suitable polyisobutene substituted phenol may preferably have an average molecular weight of 200 to 3000. Preferably the PIB substituent has a molecular weight of at least 225, suitably at least 250, preferably at least 275, suitably at least 300, for example at least 325 or at least 350. For example, the PIB substituent may have an average molecular weight of at least 375, preferably at least 400, suitably at least 475, for example at least 500. For example, the PIB substituent may have an average molecular weight of up to 2800, preferably up to 2600, for example up to 2500 or up to 2400. For example, the PIB substituent may have an average molecular weight of from 240 to 2500, for example from 450 to 2400, preferably from 500 to 1500, suitably from 550 to 1300.

A suitable polyisobutene substituted phenyl may include a PIB substituent having an average molecular weight of from 200 to 600.

A suitable polyisobutene substituted phenyl may include a PIB substituent having an average molecular weight of from 500 to 1000.

A suitable polyisobutene substituted phenyl may include a PIB substituent having an average molecular weight of from 700 to 1300.

A suitable polyisobutene substituted phenyl may include a PIB substituent having an average molecular weight of from 1000 to 2000.

A suitable polyisobutene substituted phenyl may include a PIB substituent having an average molecular weight of from 1700 to 2600, for example 2000 to 2500.

The one or more aldehyde-alkylphenol copolymers may be selected from one or more compounds of formula (II) and/or (III):

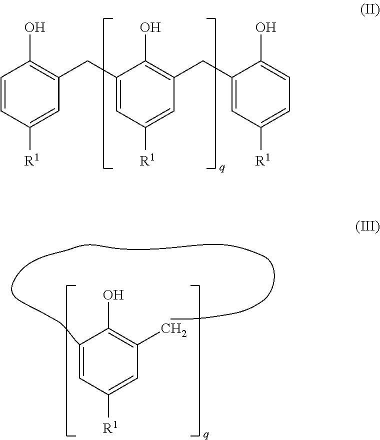

wherein each R¹ independently represents hydrogen or a hydrocarbyl group and q is at least 1.

Preferably q is from 2 to 12, preferably from 5 to 9; and R¹ is C₃-C₂₆, such as C₃-C₂₄, preferably C₄-C₁₂, alkyl (for example isononyl, isobutyl or amyl), C₆-C₁₂ aryl or hydroxyaryl, or C₇-C₁₂ aralkyl.

As the skilled person will appreciate the aldehyde-alkylphenol copolymers may be prepared from mixtures of monomers, in particular compounds in which R¹ comprises a mixture of alkyl groups. Further suitable aldehyde-allylphenol copolymers for use herein include compounds of formula (II) in which the terminal phenol groups are further functionalised, for example by reaction with a fatty acid or an amine and an aldehyde via a Mannich reaction. Compounds of this type are described, for example, in US2007/221539.

Preferably the aldehyde-alkylphenol copolymer(s) have a number average molecular weight of from 400 to 20000 or from 500 to 20000, preferably from 400 to 10000 or from 1000 to 10000, more preferably from 400 to 1500 or from 1500 to 5000, for example from 400 to 3500 or from 2000 to 3500 g/mol.

The additive composition may comprise the one or more aldehyde-alkylphenol copolymer(s) in any suitable amount. For example, the additive composition may comprise at least 5 wt %, such as at least 10 wt % or at least 15 wt % of the one or more aldehyde-alkylphenol copolymers, and/or the additive composition may comprise up to 45 wt %, such as up to 40 wt % or up to 35 wt % of the aldehyde-alkylphenol copolymer(s). The additive composition may, for example, comprise from 5 to 45 wt %, or from 10 to 40 wt %, such as from 15 to 35 wt %, of the aldehyde-alkylphenol copolymers.

The additive composition may comprise from 10 to 40 wt % of the one or more alkoxylated amine compounds and from 10 to 40 wt % of the one or more aldehyde-alkylphenol copolymers.

The additive composition may comprise from 15 to 35 wt % of the one or more alkoxylated amine compounds and from 15 to 35 wt % of the one or more aldehyde-alkylphenol copolymers.

The additive composition may comprise one or more additional components in any suitable amount. The additive composition may further comprise a solvent. The additive composition may comprise any suitable solvent. For example the additive composition may comprise one or more solvents selected from an aromatic hydrocarbon (such as benzene, toluene, xylene or a C₁₁-C₁₄ aromatic hydrocarbon), a light or heavy aromatic naphtha, an aliphatic hydrocarbon (such as n-alkanes, isoalkanes, cyclic alkanes), a paraffin (which may be a long-chain paraffin or a mixture of paraffins such as kerosene) a heterocyclic compound with high boiling point and combinations thereof. For example, a preferred solvent may be kerosene.

The additive composition may comprise a solvent in any suitable amount. For example, the additive composition may comprise at least 10 wt %, such as at least 15 wt % or at least 20 wt % of the solvent, and/or the additive composition may comprise up to 50 wt %, such as up to 30 wt %, or such as up to 25 wt % of the solvent. The additive composition may, for example, comprise from 10 to 50 wt % or from 20 to 50 wt %, for example from 10 to 30 wt %, such as from 15 to 25 wt %, of the solvent.

The additive composition may comprise from 10 to 40 wt % of the one or more alkoxylated amine compounds, from 10 to 40 wt % of the one or more aldehyde-alkylphenol copolymers and from 20 to 50 wt % of a solvent.

The additive composition may comprise from 10 to 40 wt % of the one or more alkoxylated amine compounds, from 10 to 40 wt % of the one or more aldehyde-alkylphenol copolymers and from 10 to 30 wt % of a solvent.

The additive composition may comprise from 15 to 35 wt % of the one or more alkoxylated amine compounds, from 15 to 35 wt % of the one or more aldehyde-alkylphenol copolymers and from 20 to 50 wt % of a solvent.

The additive composition may comprise from 15 to 35 wt % of the one or more alkoxylated amine compounds, from 15 to 35 wt % of the one or more aldehyde-alkylphenol copolymers and from 10 to 25 wt % of a solvent.

The additive composition may further comprise an additional additive selected from one or more of a conductivity improver, a combustion improver, an asphaltene dispersant, a fuel antioxidant, a cold flow improver, a wax anti-setting agent, a biofuel instability inhibitor, a blended fuel separation inhibitor, a detergent and a dispersant. Suitable amounts of such additional additives (when present) would be known to persons skilled in the art and range from 0.1 to 25 wt %.

The additive composition may be added to the hydrocarbon emulsion in any suitable manner. For example, the additive composition may be dispersed within the hydrocarbon emulsion.

The method or use of the present invention may be used with any hydrocarbon emulsion from which it is desired to separate an aqueous component (e.g. water) from the hydrocarbon component of the emulsion.

Suitable hydrocarbon emulsions include those in which the hydrocarbon is selected from a residual fuel oil (such as high sulfur fuel oil, very low sulfur fuel oil and ultra low sulfur fuel oil), a distillate fuel oil, a bio-derived fuel oil, a cracked process stream, a synthetic fuel, a gas oil (such as B7 gasoil, vacuum gas oil, light heating oil, diesel, biodiesel and middle distillate) and a plastic pyrolysis oil. For example, in particular, the hydrocarbon may be selected from crude oil, heavy fuel oil, gasoline, kerosenes, diesel fuels, transformer oils, turbine oks, heating oils, marine fuels, bunker oils, lubricating oils and mixtures thereof. Preferably, the hydrocarbon may be crude oil. Typically, the hydrocarbon emulsion has formed by addition of an aqueous component (e.g. water) to the hydrocarbon component so as to form an emulsion.

The hydrocarbon emulsion may comprise a hydrocarbon component and an aqueous component.

The hydrocarbon emulsion may comprise an aqueous component, for example wherein the aqueous component may be present in an amount of less than 95 vol %, less than 90 vol %, less than 80 vol %, for example less than 60 vol %, or less than 40 vol %, suitably less than 30%, or less than 20 vol %, or less than 15 vol %.

The aqueous component of the hydrocarbon emulsion may be selected from one or more of fresh water, waste-water, sour-water, brine and saline solution. The aqueous component may have been added to the hydrocarbon component for processing purposes, such as for the removal of inorganic salts.

The additive composition may be added to the hydrocarbon emulsion in any suitable amount. For example, the additive composition may be added to the hydrocarbon emulsion at a concentration of from 0.1 ppm to 10000 ppm, for example from 1 ppm to 5000 ppm, or from 10 ppm to 1000 ppm, suitably from 30 to 500 ppm, or from 50 to 300 ppm.

The additive composition may be added to the hydrocarbon emulsion in an amount wherein the concentration of the one or more alkoxylated amine compounds is from 0.025 ppm to 2500 ppm, for example from 0.25 ppm to 1250 ppm, or from 2.5 ppm to 250 ppm, suitably from 7 to 125 ppm, or from 12 to 75 ppm.

The additive composition may be added to the hydrocarbon emulsion in an amount wherein the concentration of the one or more aldehyde-alkylphenol copolymers is from 0.025 ppm to 2500 ppm, for example from 0.25 ppm to 1250 ppm, or from 2.5 ppm to 250 ppm, suitably from 7 to 125 ppm, or from 12 to 75 ppm.

The additive composition may be added to the hydrocarbon emulsion in an amount wherein the concentration of the active components (i.e. the one or more alkoxylated amine compounds and the one or more aldehyde-alkylphenol copolymers) is from 0.05 ppm to 5000 ppm, for example from 0.5 ppm to 2500 ppm, or from 5 ppm to 500 ppm, suitably from 15 to 250 ppm, or from 25 to 150 ppm.

The additive composition may comprise the one or more alkoxylated amine compounds and the one or more aldehyde-alkylphenol copolymers in a weight ratio in the range of 1:2 to 2:1, such as a weight ratio of about 1:1.

According to a third aspect of the present invention, there is provided a method of improving the demulsification of a hydrocarbon emulsion, the method comprising adding an additive composition to the hydrocarbon emulsion, wherein the additive composition comprises (i) one or more alkoxylated amine compounds and (ii) one or more aldehyde-alkylphenol copolymers.

According to a fourth aspect of the present invention, there is provided the use of an additive composition to improve the demulsification of a hydrocarbon emulsion, wherein the additive composition comprises (i) one or more alkoxylated amine compounds and (i) one or more aldehyde-alkylphenol copolymers.

According to a fifth aspect of the present invention, there is provided a method of improving the demulsification action of one or more alkoxylated amine compounds in a hydrocarbon emulsion, the method comprising admixing the one or more alkoxylated amine compounds with one or more aldehyde-alkylphenol copolymers to provide an additive composition, and adding the additive composition to the hydrocarbon emulsion.

According to a sixth aspect of the present invention, there is provided the use of one or more aldehyde-alkylphenol copolymers to improve the demulsification action of one or more alkoxylated amine compounds in a hydrocarbon emulsion.

Features of the third, fourth, fifth and sixth aspects of the invention, for example including of the additive compositions, the alkoxylated amine compounds and the aldehyde-alkylphenol copolymers, are as set out herein in reaction to the method and use of the first and second aspects.

References to improving the demulsification or demulsification action may refer to improvements such as by accelerating the speed of separation, improving clean separation of the aqueous component (for example water) from the hydrocarbon component, increasing the volume of water separated and/or minimising residual (or unresolved) emulsion, as discussed herein.

In particular, in relation to the sixth aspect, the one or more aldehyde-alkylphenol copolymer(s) will be known to persons skilled in the art and are as discussed above. The aldehyde-alkylphenol copolymer(s) do not comprise any alkoxy groups or residues, i.e. the aldehyde-alkylphenol copolymer(s) are non-alkoxylated. The one or more aldehyde-alkylphenol copolymers may be selected from one or more compounds of formula (II) and/or (III) as discussed above.

### BRIEF DESCRIPTION OF THE FIGURES

For a better understanding of the invention, and to show how exemplary embodiments of the same may be carried into effect reference will be made, by way of example only, to the accompanying FIGURES, in which:

FIG. 1 shows the results of the demulsification tests of Example 1, in which different additives were tested for their demulsifying properties.

FIG. 2 shows a photograph of the demulsification test tubes taken at 60 minutes after each additive of Example 1 was added.

The invention will now be further described with reference to the following non-limiting examples.

### Example 1

An additive composition 1 comprising an alkoxylated amine compound (wherein EO represents an ethylene oxide residue and PO represents a propylene oxide residue), an aldehyde-alkylphenol copolymer and a solvent was provided as shown in Table 1:

TABLE 1

| Component | wt % |
|---|---|
| kerosene hydrocarbon (C₁₁-C₁₄) solvent | 24 |
| formaldehyde-alkylphenol resin* | 50.8 |
| (CAS: 31605-35-3; 50% active) | |
| ethylenediamine EO/PO block copolymer | 25.2 |
| (CAS: 26316-40-5; 100% active)** | |

*formaldehyde-paranonylphenol resin
**MW 6,000 g/mol

### Demulsification Tests

The demulsification tests follow the commonly known “bottle test”, based on the BS & W test as described in ASTMD4007-11:

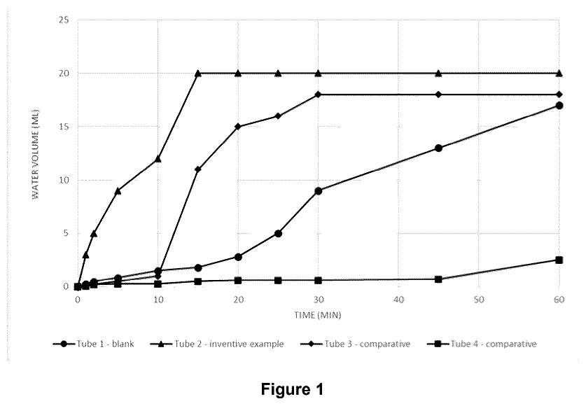

20 mL of tsp water was added to 80 mL of crude oil in a series of graduated centrifuge tubes. The water-crude oil mixtures were emulsified through vigorous agitation using a CAT Homogenizer X620 at 8000 rpm for 10 seconds. The additives listed in Table 2 were added separately to each tube and the tubes were shaken for 2 minutes, ensuring that tube was inverted to allow liquid at the tip to drain into bulk solution. The tubes were then placed in a water bath at 60° C. for 60 minutes. Visual observations and recording of fluid phase separation as separated water volume were made at 0, 1, 2, 5, 10, 15, 20, 25, 30, 45 and 60 minutes. The results are shown in Table 3 and FIG. 1.

TABLE 2

| | | Added amount of | Total actives |
|---|---|---|---|
| Tube No. | Additive | additive (ppm) | (ppm) |
| 1 | Blank (no additive) | — | — |
| (comparative) | | | |
| 2 | Additive composition 1 as per Table 1 | 200 | 101.2 |
| | (inventive example) | | |
| 3 | Ethoxylated and propoxylated | 100 | 100 |
| (comparative) | ethylenediamine (CAS: 26316-40-5; | | |
| | 100% active)*** | | |
| 4 | Formaldehyde-alkylphenol resin | 200 | 100 |
| (comparative) | (CAS: 9003-35-4; 50% active)**** | | |

***MW 6,000 g/mol
****formaldehyde-paranonylphenol resin

TABLE 3

| | Tube 1 | Tube 2 | Tube 3 | Tube 4 |
|---|---|---|---|---|
| Time | Water | Water | Water | Water |
| (min) | volume (mL) | volume (mL) | volume (mL) | volume (mL) |
| 0 | 0 | 0 | 0 | 0 |
| 1 | 0.25 | 3 | 0.1 | 0.05 |
| 2 | 0.5 | 5 | 0.2 | 0.2 |
| 5 | 0.85 | 9 | 0.5 | 0.25 |
| 10 | 1.5 | 12 | 1 | 0.25 |
| 15 | 1.8 | 20 | 11 | 0.5 |
| 20 | 2.8 | 20 | 15 | 0.6 |
| 25 | 5 | 20 | 16 | 0.6 |
| 30 | 9 | 20 | 18 | 0.6 |
| 45 | 13 | 20 | 18 | 0.7 |
| 60 | 17 | 20 | 18 | 2.5 |

FIG. 1 shows the demulsifying performance of an alkoxylated amine compound alone, an aldehyde-alkylphenol copolymer alone, and an additive composition comprising both an alkoxylated amine compound and an aldehyde-alkylphenol copolymer, compared to when no additive is present.

The aldehyde-alkylphenol copolymer (Tube 4 in Table 3) provides a deficient demulsification effect, even outperformed by the blank teat (Tube 1 in Table 3) after 60 minutes. Surprisingly, the additive composition used in the method of the present invention (Tube 2 in Table 3) outperformed all tests in separation efficiency and speed, by completely separating the 20 mL of water initially added after 15 minutes.

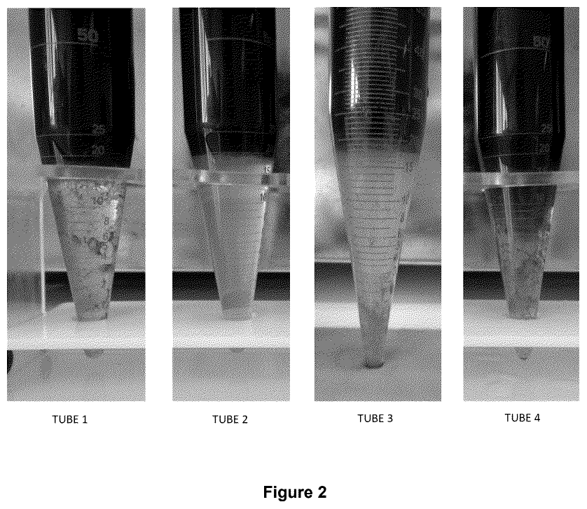

FIG. 2 is a visual assessment of the demulsification teats at 60 minutes after each additive from Table 2 was added. The additive composition used in the method of the present invention (Tube 2 in Table 3) had no observable crude oil trace on the walls of the tube and displayed the beat results in achieving a clean water-hydrocarbon interface (as assessed visually).

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A method of demulsifying a hydrocarbon emulsion, the method comprising adding an additive composition to the hydrocarbon emulsion, wherein the additive composition comprises (i) one or more alkoxylated amine compounds and (ii) one or more aldehyde-alkylphenol copolymers.

2. (canceled)

3. A method of improving the demulsification of a hydrocarbon emulsion, the method comprising adding an additive composition to the hydrocarbon emulsion, wherein the additive composition comprises (i) one or more alkoxylated amine compounds and (ii) one or more aldehyde-alkylphenol copolymers.

4. (canceled)

5. A method of improving the demulsification action of one or more alkoxylated amine compounds in a hydrocarbon emulsion, the method comprising admixing the one or more alkoxylated amine compounds with one or more aldehyde-alkylphenol copolymers to provide an additive composition, and adding the additive composition to the hydrocarbon emulsion.

6. (canceled)

7. The method of claim 1, wherein the one or more alkoxylated amine compounds are independently selected from one or more of an alkoxylated monoamine and one or more of an alkoxylated polyamine.

8. The method of claim 1, wherein the one or more alkoxylated amine compounds each comprise one or more alkylene oxide residues independently selected from ethylene oxide residues, propylene oxide residues and butylene oxide residues.

9. The method of claim 1, wherein the one or more alkoxylated amine compounds are selected from one or more compounds of formula (IA): 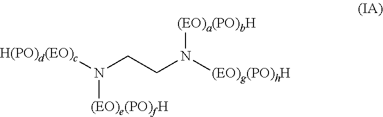
wherein EO represents an ethylene oxide residue, PO represents a propylene oxide residue and at least one of a, b, c, d, e, f, g and h is not 0.

10. The method of claim 1, wherein the one or more alkoxylated amine compounds are selected from one or more compounds of formula (IB): 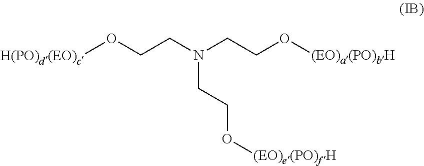
wherein EO represents an ethylene oxide residue, PO represents a propylene oxide residue and at least one of a′, b′, c′, d′, e′, and f′ is not 0.

11. The method of claim 1, wherein the one or more aldehyde-alkylphenol copolymers are selected from one or more copolymers of formaldehyde and an alkylphenol.

12. The method of claim 1, wherein the one or more aldehyde-alkylphenol copolymers are selected from one or more compounds of formula (ii) or (III): 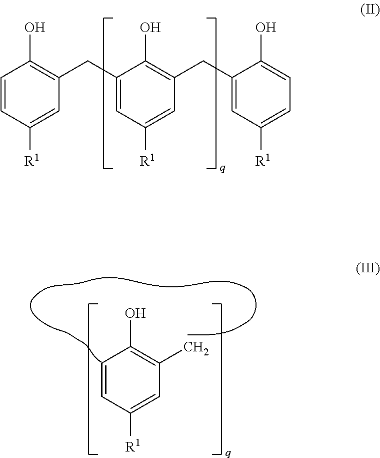
wherein each R¹ independently represents hydrogen or a hydrocarbyl group and q is at least 2.

13. The method of claim 1, wherein the additive composition further comprises a solvent, for example one or more solvents selected from an aromatic hydrocarbon, a light or heavy aromatic naphtha, an aliphatic hydrocarbon, a long-chain paraffin, a heterocyclic compound with high boiling point and combinations thereof.

14. The method of claim 1, wherein the additive composition further comprises an additional additive selected from one or more of a conductivity improver, a combustion improver, an asphaltene dispersant, a fuel antioxidant, a cold flow improver, a wax anti-setting agent, a biofuel instability inhibitor, a blended fuel separation inhibitor, a detergent, a dispersant and combinations thereof.

15. The method of claim 1, wherein the additive composition comprises from 5 to 45 wt % of the one or more alkoxylated amine compounds and from 5 to 45 wt % of the one or more aldehyde-alkylphenol copolymers.

16. The method of claim 1, wherein the additive composition is added to the hydrocarbon emulsion at a concentration of from 0.1 ppm to 10000 ppm, for example from 1 ppm to 5000 ppm, or from 10 ppm to 1000 ppm.

17. The method of claim 1, wherein the hydrocarbon is selected from a residual fuel oil, a distillate fuel oil, a bio-derived fuel oil, a cracked process stream, a synthetic fuel, a gas oil and a plastic pyrolysis oil.

18. The method of claim 1, wherein the hydrocarbon emulsion comprises an aqueous component;
wherein the aqueous component is present at less than 80 vol %, for example less than 60 vol %, or less than 40 vol %, suitably less than 30%, or less than 20 vol %.

19. The method to claim 18, wherein the aqueous component is selected from one or more of fresh water, waste-water, sour-water, brine, and saline solution.
